(19) United States
(12) Patent Application Publication
(10) Pub. No.: US 2018/0211146 A1
(43) Pub. Date: Jul. 26, 2018

(54) METHOD FOR RADIO FREQUENCY IDENTIFICATION OF OIL AND GAS EQUIPMENT

(71) Applicant: "HORIZONTY ROSTA" LLC, Moscow (RU)

(72) Inventor: Dmitry Nikolaevich TOKAREV, St. Petersburg (RU)

(21) Appl. No.: 15/936,995

(22) Filed: Mar. 27, 2018

Related U.S. Application Data
(63) Continuation of application No. PCT/RU2015/000639, filed on Oct. 2, 2015.

(51) Int. Cl. G06K 19/077; E21B 41/00

(52) U.S. Cl. CPC G06K 19/0776; E21B 41/00

(57) ABSTRACT

There is disclosed a method for embedded mounting of a radio frequency identification tag into an oil and gas equipment housing. The method comprises: embedding the radio frequency identification tag into an opening defined in the oil and gas equipment housing at a distance from 0.001 mm to 40 mm from an oil and gas equipment housing surface.

### CROSS-REFERENCE

The present application is a continuation of International Patent Application no. PCT/RU2015/000639, filed on Oct. 2, 2015, entitled “METHOD FOR MOUNTING A RADIO-FREQUENCY TAG INTO THE HOUSING OF OIL AND GAS EQUIPMENT”. This application is incorporated by reference herein in its entirety.

### FIELD OF THE TECHNOLOGY

The technology relates to variants of embedded mounting of a radio frequency identification tag into the housing of oil and gas equipment. The radio frequency tag is embedded in the opening of the housing of oil and gas equipment at a distance from 0.001 mm to 40 mm from the equipment surface, depending on its dimensions.

### BACKGROUND OF THE TECHNOLOGY

Patent document WO 0079239 A1 discloses a method of identification by means of a radio frequency identification tag. The tag comprises at least two openings that are used for installation of a tool by means of which the tag is inserted into the opening. The opening into which the tag is installed is threaded. The solution of the document WO 0079239 A1 proposes to lock the tag by applying an adhesive composition to the threaded part of the opening. Drilling the installation openings results in brittleness of the tag and necessity to increase its dimensions so that it is possible to place both an identifier and installation openings on it. The tag is mounted through adhesive joint and only in the area of the threaded part. It causes openings to be penetrated with contaminants inside the product, and in addition, under conditions of high load of the product (temperature, mechanical and other loads) adhesive fixation along the thread may be insufficient. In addition, refining the housing will lead to the tag destruction.

### SUMMARY

There is disclosed a method for embedded mounting of a radio frequency identification tag into an oil and gas equipment housing. The method comprises:

embedding the radio frequency identification tag into an opening defined in the oil and gas equipment housing at a distance from 0.001 mm to 40 mm from an oil and gas equipment housing surface.

In some embodiments of the method, the method further comprises:

covering a top surface of the radio frequency identification tag with a compound such that it is flush with the oil and gas equipment housing surface.

In some embodiments of the method, the opening is a groove in a coupling, the coupling being embedded in the oil and gas equipment housing.

In some embodiments of the method, the method further comprises applying an adhesive joint to tag thread and tag back end surfaces of the radio frequency identification tag prior to embedding the radio frequency identification tag into the opening.

In some embodiments of the method, the method further comprises attaching the radio frequency identification tag to the opening by spot welding.

In some embodiments of the method, the method further comprises, during embedding of the radio frequency identification tag into the opening, the opening having an external opening dimension smaller than the internal opening dimension, and the radio frequency identification tag having a tag dimension larger than the external opening dimension,

increasing temperature of the oil and gas equipment housing proximate to the opening to fit the radio frequency identification tag into the opening; and

allowing for natural cooling of the oil and gas equipment housing proximate to the opening.

In some embodiments of the method, the method further comprises, during embedding of the radio frequency identification tag,

decreasing temperature of the radio frequency identification tag.

In some embodiments of the method, the method further comprises applying an adhesive joint to tag thread and tag back end surfaces of the radio frequency identification tag prior to embedding the radio frequency identification tag into the opening.

In some embodiments of the method, the method further comprises attaching the radio frequency identification tag to the opening by spot welding.

In some embodiments of the method, the opening is one of: threaded and un-threaded.

In accordance with another broad aspect of the present technology, there is provided an oil and gas equipment comprising:

a housing having an oil and gas equipment housing surface and defining an opening;

a radio frequency identification tag embedded into the opening at a distance selected from 0.001 mm to 40 mm from the oil and gas equipment housing surface.

The method as described herein is aimed at eliminating disadvantages of the prior art and improves the efficiency and reliability of the radio frequency identification tag operation in the process of industrial use by increasing the reliability of embedding the tag into the equipment, reducing the tag dimensions, increasing its dirt resistance, reducing the negative effect of embedding the tag into the equipment housing.

The method of embedded mounting of radio frequency identification tag (RFID) as described herein allows identifying oil and gas equipment. The method includes embedded mounting of the tag in the housing of oil and gas equipment via an opening which either comprises thread or is unthreaded at a distance from 0.001 mm to 40 mm from the equipment surface, depending on its dimensions. The top surface of the tag is covered with a compound flush with the equipment surface.

In at least one embodiment, in case of minor aggression, the compound does not need to be applied to the tag, and the tag may be installed without adhesive.

The method may also include making a groove of any shape in the equipment housing, mounting of the tag in the groove and its fixation by adhesive joint along all contact surfaces of said tag and surfaces of the opening. The indicated tag receives a radio signal and transmits a signal comprising the identification data.

In another embodiment of this technology, the embedded mounting of the radio frequency identification tag to the housing of the oil and gas equipment includes making a groove of any shape in the equipment housing the input dimension of which is smaller than the lower one. In this embodiment, the temperature of the equipment housing can be increased, at least in the area of the said groove, and/or the temperature of the RFID tag can be decreased. The tag is mounted in the groove having a smaller dimension than the input groove size. The use of this embodiment helps to equalize temperatures of the tag and the equipment housing, while providing a radio signal to the said tag and receiving a signal comprising identification data.

A further embodiment of this disclosure, as an embedded mounting of the radio frequency identification tag in the housing of oil and gas equipment, includes making a groove in the equipment housing, mounting of the tag into the groove, fixing it in the groove by spot welding, applying a radio signal to the tag and receiving a signal comprising identification data. The tag is embedded in the opening at a distance from 0.001 mm to 40 mm from the equipment surface, depending on the equipment dimension, which allows keeping the radio frequency tag in serviceable condition when the equipment housing is worn out or thin out during operation or repair. The top surface of the tag is covered with a compound flush with the equipment surface. In case of a slight aggressive impact on the tag, the compound may not be applied.

The technical result is the preservation of the radio frequency identification tag in serviceable condition when the equipment housing is worn out (thin out) during operation or repair, increasing the product dirt resistance and the tag fixation reliability, reducing the negative impact of embedding the tag into the equipment housing on the equipment strength. The tag is embedded in a groove of any shape made in the equipment housing, including the one having an input groove size smaller than the lower groove size; the temperature can increase and decrease; the tag can be fixed in the groove by means of spot welding. This makes it possible to expand the variants for embedding the radio frequency tag, which has an effect on improving the efficiency and reliability of its operation in the process of industrial use.

### BRIEF DESCRIPTION OF THE DRAWINGS

The non-limiting embodiments of the present technology are illustrated with reference to the following drawings:

FIG. 1 depicts a variant of oil or gas equipment, in accordance with non-limiting embodiments of the present technology.

FIG. 2 depicts a fixation of RFID tag by means of threaded connection and adhesive, in accordance with non-limiting embodiments of the present technology.

FIG. 3 depicts an arrangement of the RFID tag in threaded groove, in accordance with non-limiting embodiments of the present technology.

FIG. 4 depicts a fixation of RFID tag by means of adhesive joint, in accordance with non-limiting embodiments of the present technology.

FIG. 5 depicts an arrangement of the RFID tag in unthreaded groove, in accordance with non-limiting embodiments of the present technology.

FIG. 6 depicts a fixation of the RFID tag by pressing into back taper groove, in accordance with non-limiting embodiments of the present technology.

FIG. 7 depicts an arrangement of the RFID tag in back taper groove, in accordance with non-limiting embodiments of the present technology.

FIG. 8 depicts a fixation of RFID tag by means of spot welding, in accordance with non-limiting embodiments of the present technology.

FIG. 9 depicts an arrangement of the RFID tag in unthreaded groove, variant for spot welding, in accordance with non-limiting embodiments of the present technology.

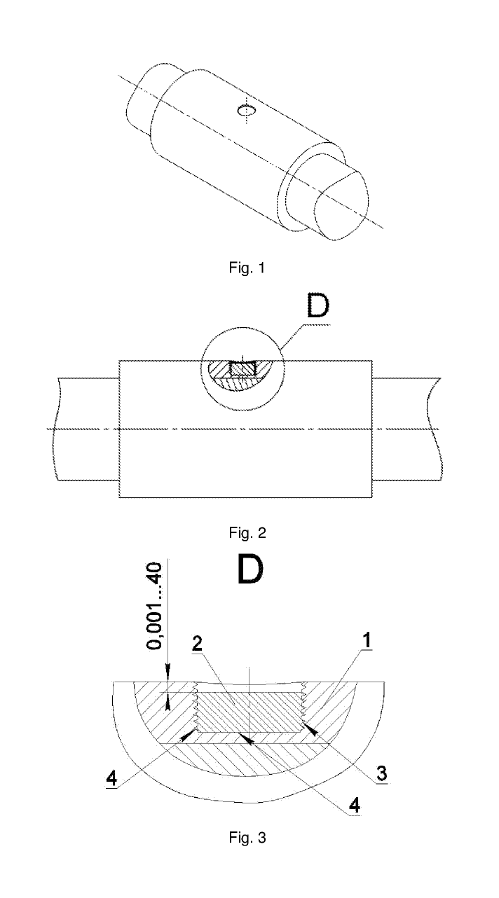

### DETAILED DESCRIPTION

The technology is illustrated by the drawings, in which: 1—body or housing of oil or gas equipment, 2—RFID tag, 3—connecting surface (thread), 4—connecting element (adhesive).

The technology described herein provides a method for radio frequency identification of oil and gas equipment, in particular downhole equipment, which includes making an opening in the equipment, which may have a threaded surface, applying an adhesive to the surface of a radio frequency identification tag corresponding to the opening wall, sending a radio signal to the said tag and receiving a signal comprising identification data.

One embodiment of the present technology provides a method for radio frequency identification of oil and gas equipment, which includes making an opening in the equipment, mounting of the radio frequency identification tag into it, fixing the tag in the opening by means of adhesive on all contact surfaces of the tag and the opening, applying a radio signal to the tag and receiving a signal comprising identification data.

Another embodiment of the present technology provides a method for radio frequency identification of oil and gas equipment, which includes making an opening in equipment, the input dimension of which is smaller than the lower one, which allows for an increase in the temperature of the equipment housing, at least in the area of the said groove, and/or a decrease of the temperature of the radio frequency identification tag; mounting of the radio frequency identification tag into the groove having a smaller size than the input groove dimension that facilitates alignment of tag and equipment housing temperatures, applying a radio signal to the tag, and receiving a signal comprising identification data.

Additionally, described herein is the method of the oil and gas equipment RFID, which includes making a groove in the equipment housing, mounting of the radio frequency identification tag into the groove, fixing it in the groove by spot welding, applying a radio signal to the tag and receiving a signal comprising identification data.

According to one embodiment of this technology, the tag is embedded in the opening at a distance from 0.001 mm to 40 mm from the equipment surface, depending on the equipment dimension, which allows keeping the tag in serviceable condition when the equipment housing is worn out or thin out during operation or repair.

This solution allows the simultaneous use of several methods of mounting of the tag in the equipment housing, for example, spot welding, adhesive joint, temperature jamming, etc. The implementation of several methods of mounting at the same time allows increasing the reliability of the equipment-tag connection.

A method for embedded mounting of the RFID tag in any oil or gas equipment using a threaded connection (with or without adhesive) to prevent the RFID tag from being unscrewed from the groove (FIG. 2).

To mount the RFID tag (2), an opening with a diameter corresponding to this type of RFID tag is drilled in the equipment housing (1). A thread is cut in the opening (3), according to the RFID tag thread specification. An adhesive layer (4) can be applied to the thread of the RFID tag (2) to prevent it from being unscrewed. Also, the adhesive layer can be applied to the RFID tag toe end (back end) to ensure better fixation in the coupling groove (1) (FIG. 3). The radio frequency tag shall be embedded in an opening at a distance from 0.001 mm to 40 mm from the equipment surface, depending on its dimensions.

Embedding allows keeping the radio frequency tag in working condition when the equipment housing is worn out (thin out) during operation or repair.

The top surface of the tag is covered with a compound. In case of minor aggression, the compound may not be applied to the tag, and the tag may be installed without adhesive.

A method for embedded mounting of the RFID tag through fixing by means of adhesive joint in the coupling groove over all contacting faces (FIG. 3).

For embedded mounting of the RFID tag (2), a groove with dimensions corresponding to this type of RFID tag is made in the coupling (1). An adhesive layer (4) is applied to contacting faces of the tag (2) to prevent it from being unscrewed (FIG. 5). The adhesive can be applied to some surfaces of the tag or equipment.

The radio frequency tag shall be embedded in an opening or groove at a distance from 0.001 mm to 40 mm from the equipment surface, depending on its dimensions. Embedding allows keeping the radio frequency tag in working condition when the equipment housing is worn out (thin out) during operation or repair.

The top surface of the tag is covered with a compound. In case of a slight aggressive impact on the tag, the compound may not be applied.

The method for pressing the RFID tag into the back taper groove by heating the seating area of the coupling by several degrees, sufficient to mount the RFID tag in the groove, followed by natural cooling (FIG. 5).

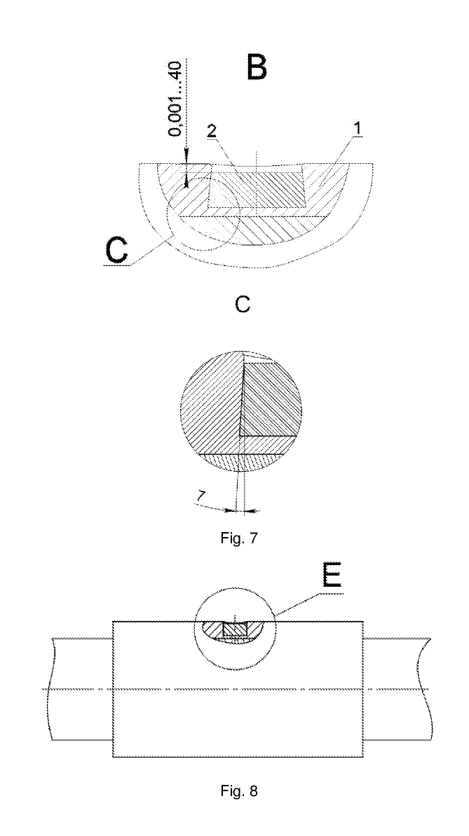

To mount the RFID tag (2), a back taper groove the size of which corresponds to this type of RFID (7) is made in the coupling (1), sufficient to securely fix the RFID tag (the opening taper angle is selected individually depending on the size of a certain RFID tag). The equipment (1) undergoes forced heating by an amount sufficient to place the RFID tag (2) in the groove (FIG. 7).

After mounting of the RFID tag in the coupling groove, the coupling is naturally cooled to prevent sudden changes in the temperature gradient, and as a result, possible curving of the RFID tag.

The radio frequency tag shall be embedded in a groove at a distance from 0.001 mm to 40 mm from the equipment surface, depending on its dimensions. Embedding allows keeping the radio frequency tag in working condition when the equipment housing is worn out (thin out) during operation or repair.

The top surface of the tag is covered with a compound. In case of a slight aggressive impact on the tag, the compound may not be applied.

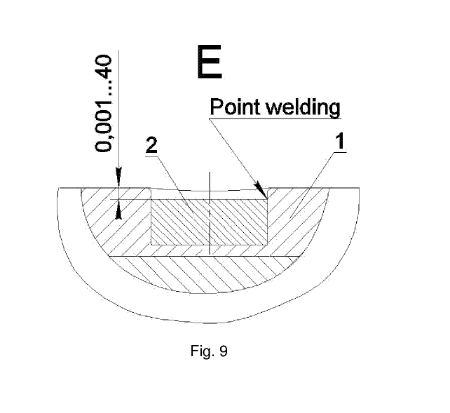

The method for spot welding of the RFID tag to the coupling at several points (FIG. 5). To fix the RFID tag (2), an opening with a dimension corresponding to this type of RFID tag is drilled in the coupling (1). The RFID tag is placed in the groove (2). To mount the RFID tag (2) in the coupling groove (1), spot welding is used at several, equidistant points (7) (FIG. 9).

In one non-limiting embodiment, the radio frequency tag shall be embedded in an opening at a distance from 0.001 mm to 40 mm from the equipment surface, depending on its dimensions.

Embedding may allow keeping the radio frequency tag in working condition when the equipment housing is worn out (thin out) during operation or repair.

The top surface of the tag is covered with a compound. In case of a slight aggressive impact on the tag, applying the compound may be omitted.

A method for mounting of the RFID tag in any oil or gas equipment using a threaded connection (with or without adhesive) to prevent the RFID tag from being unscrewed from the groove (FIG. 2).

To mount the RFID tag (2), an opening with a diameter corresponding to this type of RFID tag is drilled in the equipment housing (1). A thread is cut in the opening (3), according to the RFID tag thread specification. An adhesive layer (4) can be applied to the thread of the RFID tag (2) to prevent it from being unscrewed. Also, the adhesive layer can be applied to the RFID tag toe end (back end) to ensure better fixation in the coupling groove (1) (FIG. 3). The radio frequency tag shall be embedded in an opening at a distance from 0.001 mm to 40 mm from the equipment surface, depending on its dimensions.

Embedding allows keeping the radio frequency tag in working condition when the equipment housing is worn out (thin out) during operation or repair.

The top surface of the tag is covered with a compound. In case of minor aggression, the compound may not be applied to the tag, and it can be installed without adhesive.

A method for mounting of the RFID tag through fixing by means of adhesive joint in the coupling groove over all contacting faces (FIG. 3).

To mount the RFID tag (2) in the coupling (1), a groove with dimensions corresponding to this type of RFID tag is made. An adhesive layer (4) is applied to contacting faces of the tag (2) to prevent it from being unscrewed (FIG. 5). The adhesive can be applied to some surfaces of the tag or equipment.

The radio frequency tag shall be embedded in an opening or groove at a distance from 0.001 mm to 40 mm from the equipment surface, depending on its dimensions. Embedding allows keeping the radio frequency tag in working condition when the equipment housing is worn out (thin out) during operation or repair.

The top surface of the tag is covered with a compound. In case of a slight aggressive impact on the tag, the compound may not be applied.

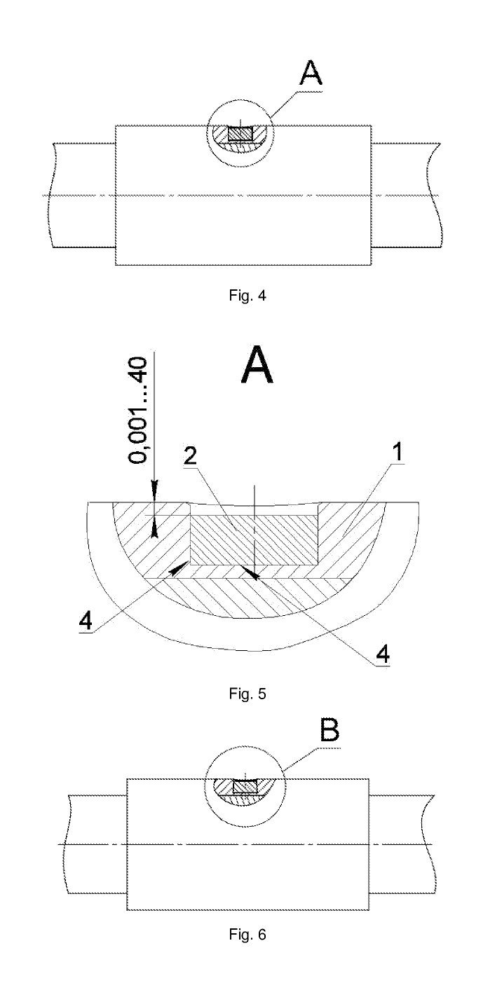

The method for pressing the RFID tag into the back taper groove by heating the seating area of the coupling by several degrees, sufficient to place the RFID tag in the groove, followed by natural cooling (FIG. 4).

To mount the RFID tag (2), a back taper groove the size of which corresponds to this type of RFID (7) is made in the coupling (1), sufficient to securely fix the RFID tag (the opening taper angle is selected individually depending on the size of a certain RFID tag). The equipment (1) undergoes forced heating by an amount sufficient to place the RFID tag (2) in the groove (FIG. 7).

After mounting of the RFID tag in the groove, the equipment is naturally cooled to prevent sudden changes in the temperature gradient, and as a result, possible curving of the RFID tag.

The radio frequency tag shall be embedded in a groove at a distance from 0.001 mm to 40 mm from the equipment surface, depending on its dimensions. Embedding allows keeping the radio frequency tag in working condition when the equipment housing is worn out (thin out) during operation or repair.

The top surface of the tag is covered with a compound. In case of a slight aggressive impact on the tag, the compound may not be applied.

The method for spot welding of the RFID tag to the equipment at several points (FIG. 5).

To mount the RFID tag (2), an opening with a dimension corresponding to this type of RFID tag is drilled in the equipment (1). The RFID tag is mounted in the groove (2). To mount the RFID tag (2) in the coupling groove (1), spot welding is used at several, equidistant points (7) (FIG. 9).

The radio frequency tag shall be embedded in an opening at a distance from 0.001 mm to 40 mm from the equipment surface, depending on its dimensions.

Embedding allows keeping the radio frequency tag in working condition when the equipment housing is worn out (thin out) during operation or repair.

The top surface of the tag is covered with a compound. In case of a slight aggressive impact on the tag, the compound may not be applied.

1. A method for embedded mounting of a radio frequency identification tag into an oil and gas equipment housing, the method comprising:
embedding the radio frequency identification tag into an opening defined in the oil and gas equipment housing at a distance from 0.001 mm to 40 mm from an oil and gas equipment housing surface.

2. The method of claim 1, further comprising
covering a top surface of the radio frequency identification tag with a compound such that it is flush with the oil and gas equipment housing surface.

3. The method of claim 1, wherein the opening is a groove in a coupling, the coupling being embedded in the oil and gas equipment housing.

4. The method of claim 1, further comprising applying an adhesive joint to tag thread and tag back end surfaces of the radio frequency identification tag prior to embedding the radio frequency identification tag into the opening.

5. The method of claim 1, further comprising attaching the radio frequency identification tag to the opening by spot welding.

6. The method of claim 1, further comprising, during embedding of the radio frequency identification tag into the opening, the opening having an external opening dimension smaller than the internal opening dimension, and the radio frequency identification tag having a tag dimension larger than the external opening dimension,
increasing temperature of the oil and gas equipment housing proximate to the opening to fit the radio frequency identification tag into the opening; and
allowing for natural cooling of the oil and gas equipment housing proximate to the opening.

7. The method of claim 6, further comprising, during embedding of the radio frequency identification tag,
decreasing temperature of the radio frequency identification tag.

8. The method of claim 6, further comprising applying an adhesive joint to tag thread and tag back end surfaces of the radio frequency identification tag prior to embedding the radio frequency identification tag into the opening.

9. The method of claim 6, further comprising attaching the radio frequency identification tag to the opening by spot welding.

10. The method of claim 1, wherein the opening is one of: threaded and un-threaded.

11. An oil and gas equipment comprising:
a housing having an oil and gas equipment housing surface and defining an opening;
a radio frequency identification tag embedded into the opening at a distance selected from 0.001 mm to 40 mm from the oil and gas equipment housing surface.
